(19) United States
(12) Patent Application Publication
(10) Pub. No.: US 2026/0229757 A1
(43) Pub. Date: Aug. 6, 2026

(54) RESONANT UNIT, FILTER COMPRISING RESONANT UNIT, AND FILTER ASSEMBLY, ANTENNA FILTER UNIT AND RADIO COMPRISING FILTER

(71) Applicant: Telefonaktiebolaget LM Ericsson (publ), Stockholm (SE)

(72) Inventors: Juandi SONG, Beijing (CN); Jichuan ZHANG, Stockholm (SE); Yuhua XIAO, Beijing (CN)

(21) Appl. No.: 19/148,619

(22) PCT Filed: Jan. 18, 2023
(86) PCT No.: PCT/CN2023/072936

§ 371 Date: Jul. 16, 2025

(51) Int. Cl. H01P 1/20; H01P 7/10

(52) U.S. Cl. CPC H01P 1/2002; H01P 7/10

(57) ABSTRACT

The present disclosure relates to a resonant unit for a filter, comprising a one-piece dielectric body having surfaces extending in planes defined by any two of three directions X, Y, Z which are perpendicular to each other and a conductive layer covering the surfaces of the dielectric body, characterized in that, the dielectic body comprises a first dielectric block made of a first dielectric material and extending longitudinally along the Z direction and a second dielectric block made of a second dielectric material, wherein the first dielectric block is embedded in the second dielectric material with both longitudinal ends of the first dielectric block being covered by the second dielectric material, and the first dielectric material has a dielectric constant greater than that of the second dielectric material. The present disclosure also relates to a filter comprising the above-said resonant unit, a filter assembly comprising the above-said filter, and an antenna filter unit or a radio comprising the above-said filter or filter assembly.

### TECHNICAL FIELD

The present disclosure generally relates to the technical field of communication device, and more particularly, to a resonant unit, a filter comprising the resonant unit, a filter assembly, an antenna filter unit and a radio comprising the filter.

### BACKGROUND

This section introduces aspects that may facilitate better understanding of the present disclosure. Accordingly, the statements of this section are to be read in this light and are not to be understood as admissions about what is in the prior art or what is not in the prior art.

With the development of an advanced radio system, it is required to have a small-sized smart radio with high performance all the time. Highly integrated advanced antenna systems (AAS) with multi-channels and highly integrated macro system with multi-bands have been widely developed recently. In those radio systems, a radio frequency (RF) filter is one important part for selecting a desired frequency and rejecting unwanted frequency spurious of the system.

Both metal filters and ceramic waveguide (CWG) filters are widely used in those AAS system. Metal filters provide good insertion loss (IL) and power handling ability, with mature material and production technology. Much efforts have been made to minimize the size and weight based on the metal filters, such as by soldering lid, making use of sheet metal, and using semi-solid die casting technology. However, there comes a limitation for the size and weight reduction of the metal filters. Compared with a metal filter, a CWG filter has the advantages of having a small size, easy integration with a radio system by means of surface mounting technology (SMT). The thickness of the radio can be greatly reduced by using CWG filters, and the number of RF connectors are reduced by a simple SMT process. However, CWG filters in a reduced size could not provide satisfactory Q value and insertion loss.

Thus, there is a need to seek for a filter solution for the purpose of providing advanced antenna systems, Macro radio systems or radios with both small filter size and improved Q value/reduced filter loss.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

One of the objects of the disclosure is to provide an improved solution for obtaining a miniaturized filter with high Q value and high production efficiency.

According to a first aspect of the disclosure, there is provided a resonant unit for a filter, comprising a one-piece dielectric body having surfaces extending in planes defined by any two of three directions X, Y, Z which are perpendicular to each other and a conductive layer covering the surfaces of the dielectric body. The dielectic body comprises a first dielectric block made of a first dielectric material and extending longitudinally along the Z direction and a second dielectric block made of a second dielectric material, wherein the first dielectric block is embedded in the second dielectric material with both longitudinal ends of the first dielectric block being covered by the second dielectric material, and the first dielectric material has a dielectric constant greater than that of the second dielectric material.

In an embodiment of the disclosure, the first dielectric block is in the shape of a solid or hollow cylinder.

In an embodiment of the disclosure, the first dielectric block is completely covered by the second dielectric material such that the first dielectric block has all its cylindrical faces engaged with corresponding faces of the second dielectric block.

In an embodiment of the disclosure, the first dielectric block is in the form of a plate extending longitudinally along the Z direction and having a first lateral end face extending in a X-Z plane, a second lateral end face extending in a Y-Z plane, and side faces extending between the first and second lateral end faces around a Z-direction edge of the dielectic body, wherein the first lateral end face and the second lateral end face are not covered by the second dielectric material but fully or partially metalized in grounded connection with the conductive layer, and an intersection line of the planes where the first lateral end face and the second lateral end face are located is close to or coincident with the Z-direction edge.

In an embodiment of the disclosure, the side faces of the first dielectric block, when viewed along the Z direction, are flat, curved or angled.

In an embodiment of the disclosure, a cross section of the first dielectric block, which is taken along a plane perpendicular to the Z direction, is in a shape of an annular sector.

In an embodiment of the disclosure, at least one of the first lateral end face and the second lateral end face serves as a bottom of a notch formed in a corresponding surface of the dielectric body where the Z-direction edge is located.

In an embodiment of the disclosure, a recess is formed in the first lateral end face or the second lateral end face.

In an embodiment of the disclosure, a cross section of the first dielectric block, which is taken along a plane perpendicular to the Z direction, is in a shape of a sector having a central angle of about 90° and a central point located on a Z-direction edge of the dielectric body.

In an embodiment of the disclosure, a cross section of the first dielectric block, which is taken along a plane perpendicular to the Z direction, is in a shape of a semi-circle or a semi-ring having a center located on a surface of the dielectric body extending parallel to the Z direction.

In an embodiment of the disclosure, both the first and second dielectric materials are selected from ceramic materials.

In an embodiment of the disclosure, the dielectric body is made integral by having both the first dielectric block and the second dielectric block come into being during a single sintering process, or by bonding together the first dielectric block and the second dielectric block that are formed separately by sintering.

According to a second aspect of the disclosure, there is provided a filter, comprising at least one resonant unit as said in the above, a signal input port connected with the at least one resonant unit for inputting a signal into the least one resonant unit, and a signal output port connected with the at least one resonant unit for obtaining an output signal.

In an embodiment of the disclosure, the filter further comprises at least one resonator provided in connection with the at least one resonant unit, the at least one resonantor being same or different to the at least one resonant unit.

In an embodiment of the disclosure, the filter comprises one resonant unit, a signal input resonator connected with the signal input port and coupled with the resonant unit by a coupling window therebetween, and a signal output resonator coupled with the resonant unit by a coupling window therebetween and connected with the signal output port, the signal input resonator and the signal output resonator being dielectric resonators having dielectric blocks made of a dielectric material identical to the second dielectric material of the resonant unit.

In an embodiment of the disclosure, the at least one resonant unit comprises a first resonant unit, a second resonant unit, a third resonant unit and a fourth resonant unit, which are connected integrally in a 2×2 array as a one-piece main body and coupled by coupling windows therebetween so that a transmission path capable of transmitting a signal along the first resonant unit, the second resonant unit, the third resonant unit and the fourth resonant unit is formed in the filter.

In an embodiment of the disclosure, all the first dielectric blocks of the first resonant unit, the second resonant unit, the third resonant unit and the fourth resonant unit extend longitudinally in the Z direction, and cross sections of the first dielectric blocks, taken along a plane perpendicular to the Z direction, each are in a shape of an annular sector and have a central point located on one of Z-direction edges of the one-piece main body.

In an embodiment of the disclosure, the signal input port in the form of an input connector is inserted into a recess formed in a lateral end surface of the first dielectric block of the first resonant unit, and/or, the signal output port in the form of an output connector is inserted into a recess formed in a lateral end surface of the first dielectric block of the fourth resonant unit.

In an embodiment of the disclosure, a metal strip extends through a coupling window between the first resonant unit and the fourth resonant unit, with each end thereof extending into one of the second dielectric blocks of the first and fourth resonant units respectively but being spaced from the first dielectric blocks of the first and fourth resonant units.

In an embodiment of the disclosure, the metal strip is in the form of a sheet having an arc-shaped, I-shaped, H-shaped or S-shaped outline.

In an embodiment of the disclosure, all the first dielectric blocks of the first resonant unit, the second resonant unit, the third resonant unit and the fourth resonant unit extend longitudinally in the Z direction, and cross sections of the first dielectric blocks, taken along a plane perpendicular to the Z direction, each are in a shape of an annular sector, wherein the annular-sector-shaped cross sections of the first dielectric blocks of the first and second resonant units have central points located on a first Z-direction edge of the one-piece main body, and the annular-sector-shaped cross sections of the first dielectric blocks of the third and fourth resonant units have central points located on a second Z-direction edge of the one-piece main body, the first Z-direction edge being adjacent to the second Z-direction edge.

According to a third aspect of the disclosure, there is provided a filter assembly, comprising at least one filter as said in the above, and a PCB board on which the at least one filter is mounted.

In an embodiment of the disclosure, the at least one filter is mounted onto the PCB board by using surface mounting technology.

According to a fourth aspect of the disclosure, there is provided an antenna filter unit or a radio, comprising one least one filter or at least one filter assembly as said in the above.

According to the present disclosure, it allows a highly integrated low loss solution for producing a resonator, by using two dielectric blocks in one resonance cavity defined by the conductive layer, and allows for an integration of the resonator units or resonator structures, for example, by a single sintering process. The filter can be manufactured easily to have inductivity or capactive coupling in a manner as desired. Also, the filter can be miniaturized with low weight, low loss, low cost, high efficiency and reliability. High production efficiency can be obtained for the filter of the present disclosure, due to high integration of the resonator structures. The filter of the present disclosure can be used in multi-channel or multi-band base station products such as AAS systems or Macro radio systems.

### BRIEF DESCRIPTION OF THE DRAWINGS

These and other objects, features and advantages of the disclosure will become apparent from the following detailed description of illustrative embodiments thereof, which are to be read in connection with the accompanying drawings.

FIG. 1 shows a perspective view of a resonant unit according to a first embodiment of the present disclosure;

FIG. 2 shows a perspective view of a resonant unit according to a second embodiment of the present disclosure;

FIG. 3A shows an electric field (E-field) created in the resonant unit according to the second embodiment of the present disclosure;

FIG. 3B shows a magnetic field (H-field) created in the resonant unit according to the second embodiment of the present disclosure;

FIG. 4 shows a perspective view of the resonant unit according to the second embodiment of the present disclosure, with an imaginary X-Y plane transecting the resonant unit;

FIG. 5A shows a first example of a cross-sectional view of the resonant unit according to the second embodiment of the present disclosure;

FIG. 5B shows a second example of a cross-sectional view of the resonant unit according to the second embodiment of the present disclosure;

FIG. 5C shows a third example of a cross-sectional view of the resonant unit according to the second embodiment of the present disclosure;

FIG. 5D shows a fourth example of a cross-sectional view of the resonant unit according to the second embodiment of the present disclosure;

FIG. 5E shows a fifth example of a cross-sectional view of the resonant unit according to the second embodiment of the present disclosure;

FIG. 5F shows a sixth example of a cross-sectional view of the resonant unit according to the second embodiment of the present disclosure;

FIG. 5G shows a seventh example of a cross-sectional view of the resonant unit according to the second embodiment of the present disclosure;

FIG. 6 shows a perspective view of a resonant unit according to a third embodiment of the present disclosure;

FIG. 7A shows an electric field (E-field) created in the resonant unit according to the third embodiment of the present disclosure;

FIG. 7B shows a magnetic field (H-field) created in the resonant unit according to the third embodiment of the present disclosure;

FIG. 7C shows a cross-sectional view of the resonant unit according to the third embodiment of the present disclosure;

FIG. 7D shows a cross-sectional view of a variant of the resonant unit according to the third embodiment of the present disclosure;

FIG. 8 shows a cross-sectional view of a filter according to a first embodiment of the present disclosure;

FIG. 9 shows a perspective view of a filter according to a second embodiment of the present disclosure;

FIG. 10 shows a cross-sectional view of the filter according to the second embodiment of the present disclosure;

FIG. 11 shows a side view of the filter according to the second embodiment of the present disclosure;

FIG. 12 shows an exploded view of the filter according to the second embodiment of the present disclosure;

FIG. 13A shows a plan view of a metal strip for the filter according to the second embodiment of the present disclosure;

FIG. 13B shows a plan view of a first variant of the metal strip for the filter;

FIG. 13C shows a plan view of a second variant of the metal strip for the filter;

FIG. 13D shows a plan view of a third variant of the metal strip for the filter;

FIG. 14 shows a topology of the filter according to the second embodiment of the present disclosure;

FIG. 15 shows the S parameter curve of the filter according to the second embodiment of the present disclosure;

FIG. 16 shows a perspective view of a filter according to a third embodiment of the present disclosure; and

FIG. 17 shows a perspective view of a filter assembly according to the present disclosure.

### DETAILED DESCRIPTION

The embodiments of the present disclosure are described in detail with reference to the accompanying drawings. It should be understood that these embodiments are discussed only for the purpose of enabling those skilled in the art to better understand and thus implement the present disclosure, rather than suggesting any limitations on the scope of the present disclosure. Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Furthermore, the described features, advantages, and characteristics of the disclosure may be combined in any suitable manner in one or more embodiments. Those skilled in the relevant art will recognize that the disclosure may be practiced without one or more of the specific features or advantages of a particular embodiment. In other instances, additional features and advantages may be recognized in certain embodiments that may not be present in all embodiments of the disclosure.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

For reducing a filter size and improving Q value, following two kinds of filters have been studied: 1) a TM mode filter with a ceramic resonator in a metal chassis. This TM mode filter includes one end grounding solution, two ends grounding solution, and dual mode solution, which can greatly reduce the filter size, as compared with a metal filter, and at the same time, gain good Q value and filter loss. The two ends grounding solution is most attractive in size and performance. But this solution has difficulty in design because the ceramic resonator is very sensitive in mechanical force and thermal force. Also, due to the complexity in mechanical design, it is difficult to reduce the size to meet the needs of AAS, and thus it is mainly used in a macro radio system; 2) a TE mode filter with a ceramic resonator in a metal chassis. This TE mode filter gains high Q but has a large size. As a variant, a TE mode filter solution comprising a sector-shaped ceramic resonator displaced between metal plates orthogonal to each other, may help to reduce the size, but the Q value decreases. Also, ceramic parts are prone to suffer from mechanical stress caused by coefficient of thermal expansion (CTE) mismatch between ceramic material and metal plates and thus easy to break.

In view of the shortcomings of the above filter solutions, the present disclosure proposes a resonant unit which is easy to produce in a small size and has reliable and excellent RF performance with a high Q value.

### First Embodiment of Resonant Unit

FIG. 1 shows a perspective view of a resonant unit 101 according to a first embodiment of the present disclosure. The resonant unit 101 comprises a one-piece dielectric body 1010 having surfaces extending in planes defined by any two of three directions X, Y, Z which are perpendicular to each other and a conductive layer 1011 covering the surfaces of the dielectric body. The dielectic body 1010 comprises a first dielectric block 1010a made of a first dielectric material and extending longitudinally along the Z direction and a second dielectric block 1010b made of a second dielectric material. The first dielectric block 1010a is embedded in the second dielectric material with both longitudinal ends of the first dielectric block being covered by the second dielectric material. The first dielectric material has a dielectric constant greater than that of the second dielectric material. In the embodiment shown in FIG. 1, the first dielectric block 1010a is centrally located in the dielectric body 1010.

As can be seen from FIG. 1, the first dielectric block 1010a is embodied in the form of a hollow cylinder. The second dielectric material fills the hollow central space of the cylinder and also encircles the cylinder from all sides such that the first dielectric material in the form of a cylinder is completely covered or surrounded by the second dielectric material which is shaped into a cube or a cuboid block when viewed from the outside. The conductive layer 1011 covering the second dielectric block defines a resonance cavity in which the first dielectric block 1010a functions as a resonance element to be excited by an input signal and the second dielectric block 1010b functions as a transmission media for the transmission of signals therein. The first dielectric block and the second dielectric block may be formed into one piece, for example, during a single sintering process, or may be formed separately, for example, by sintering, and then bonded together.

Although it is shown in FIG. 1 that the first dielectric block is in the shape of a hollow cylinder, it can be understood that the first dielectric block 1010a can be shaped as a solid cylinder. Herein “cylinder” refers to all cylinders with flat circular or non-circular ends and straight or non-straight sides. In a preferable embodiment, the first dielectric block in the form of a solid clinder or a hollow cylinder is completely covered by the second dielectric material such that the first dielectric block has all its cylindrical faces engaged with corresponding faces of the second dielectric block.

### Second Embodiment of Resonant Unit

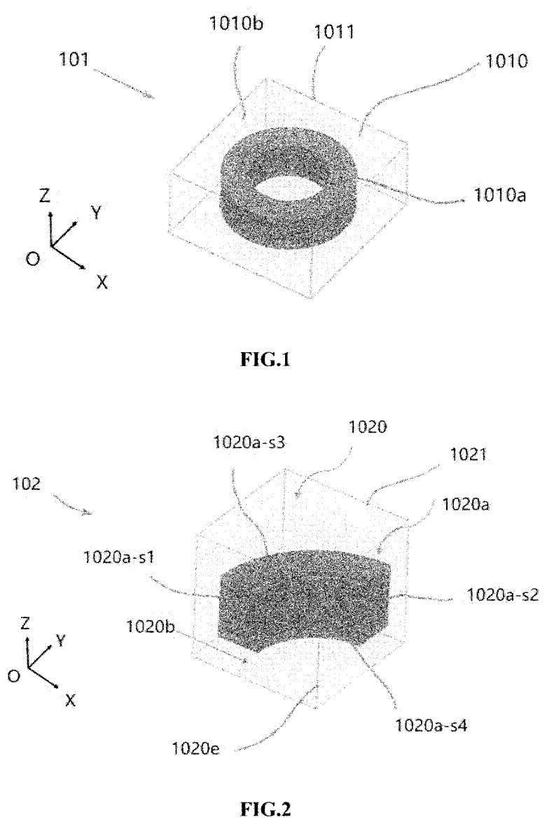

FIG. 2 shows a perspective view of a resonant unit 102 according to a second embodiment of the present disclosure. Similar to the resonant unit 101 of the first embodiment, the resonant unit 102 of the second embodiment comprises a one-piece dielectric body 1020 composed of a first dielectric block 1020a and a second dielectric block 1020b and a conductive layer 1021 covering the dielectric body.

In the resonant unit 102 of the second embodiment, the first dielectric block1020a is in the form of a plate or a slab extending longitudinally along the Z direction and having a first lateral end face 1020a-s1 extending in an X-Z plane, a second lateral end face 1020a-s2 extending in a Y-Z plane, and side faces 1020a-s3, 1020a-s4 extending between the first and second lateral end faces around a Z-direction edge 1020e of the dielectic body, wherein the first lateral end face 1020a-s1 and the second lateral end face 1020a-s2 are not covered by the second dielectric material but fully or partially metalized in grounded connection with the conductive layer 1021, and an intersection line of the planes where the first lateral end face 1020a-s1 and the second lateral end face 1020a-s2 are located is coincident with the Z-direction edge 1020e. Or, the intersection line of the planes where the first lateral end face and the second lateral end face are located may be positioned near or close to the Z-direction edge.

To put it simply, the resonant unit 102 according to the second embodiment can be like a resonant unit obtained by cutting the resonant unit 101 according to the first embodiment into four equal pieces along two symmetric Y-Z and X-Z planes of the dielectric body, taking just one quarter, and metalizing newly generated sections (including newly generated lateral end faces 1020a-s1, 1020a-s2 of the first dielectric block 1020a). So, taken in this sense, the resonant unit 102 according to the second embodiment, which may function as a basic resonant unit, can be referred to as “a quarter-type resonant unit” hereinbelow. The metalized surfaces of the “quarter-type” resonant unit are conductively connected to each other, so that a resonance cavity is created thereby.

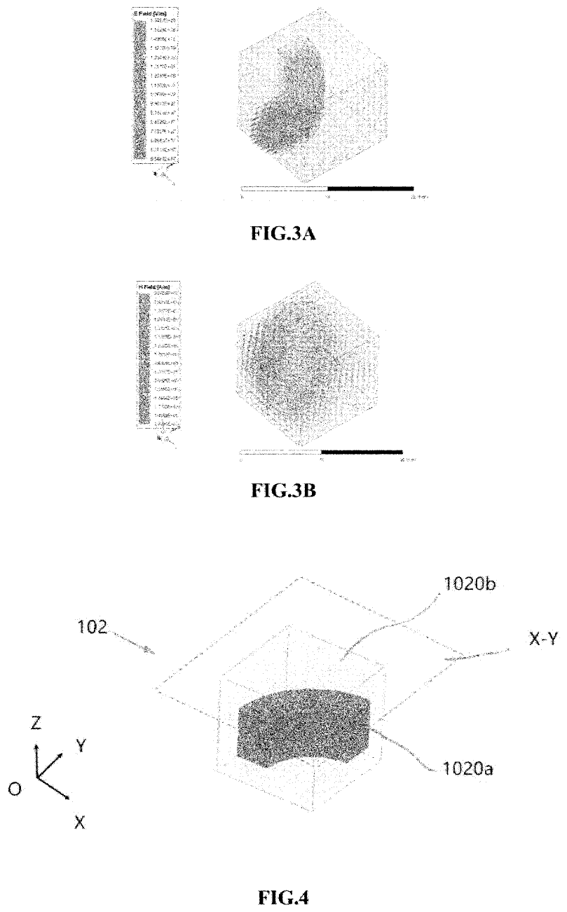

In the “quarter-type” resonant unit, E-field and H-field are created, similar to those of a TE mode resonant unit of the first embodiment. FIG. 3A and FIG. 3B show the E-field and H-field created in the quarter-type resonant unit 102. From FIG. 3A and FIG. 3B it can be seen that the quarter-type resonant unit is not only made smaller, but also able to create an energy field in a desired manner.

FIG. 4 shows an imaginary X-Y plane transecting the quarter-type resonant unit 102 at a half-length of the first dielectric block 1020a.

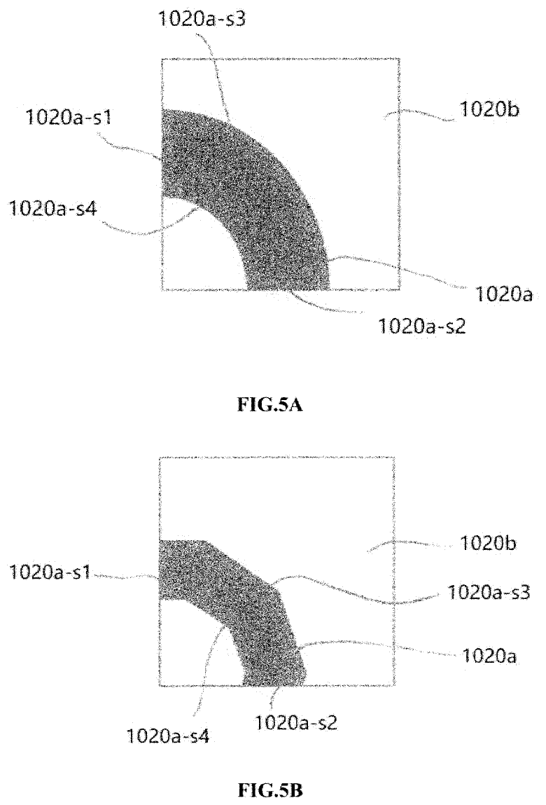

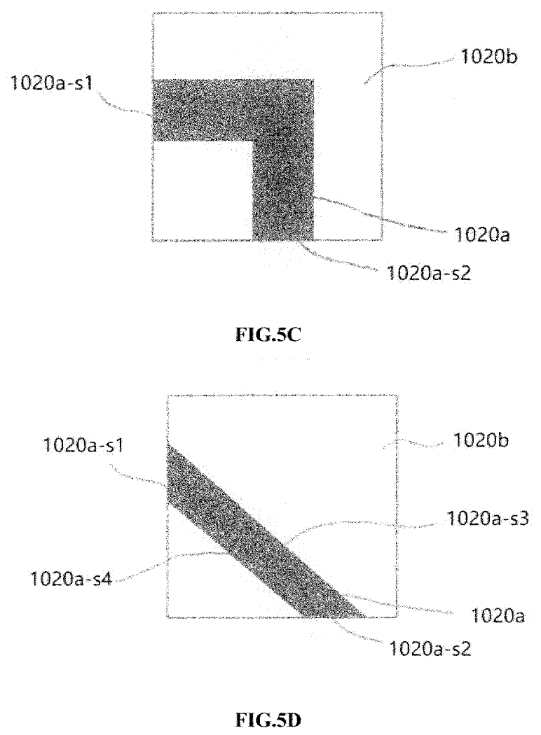

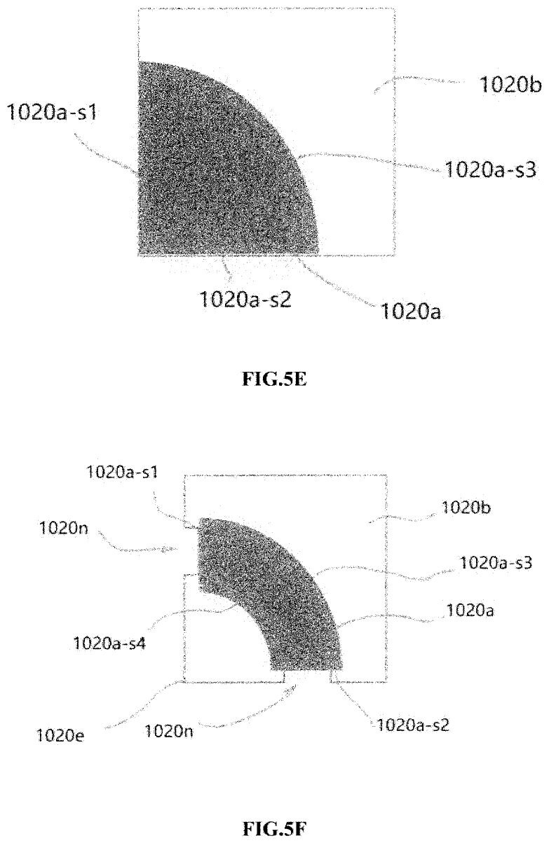

FIG. 5A shows a cross-sectional view obtained from the quarter-type resonant unit of FIG. 4, in which the first dielectric block 1020a is annular-sector-shaped with smooth arc-shaped side surfaces 1020a-s3, 1020a-s4, and the second dielectric block 1020b is square-shaped, when viewed along the Z direction.

FIG. 5B shows a variant of a cross-sectional view of FIG. 5A. As shown in FIG. 5B, a cross section of the first dielectric block 1020a, which is taken along a plane perpendicular to the Z direction, is still annular-sector-shaped but with angled profiles which are indicative of multi-faced side surfaces 1020a-s3, 1020a-s4 extending paralle to the Z direction.

FIG. 5C shows another variant of a cross-sectional view of FIG. 5A. From FIG. 5C it can be seen that the first dielectric block 1020a is substantially L-shaped when viewed along the Z direction.

FIG. 5D shows another variant of a cross-sectional view of FIG. 5A. In FIG. 5D, the first dielectric block 1020a is in a shape of a straight stripe when viewed along the Z direction. The straight stripe-shaped cross section also means the first dielectric block has flat side surfaces 1020a-s3, 1020a-s4 extending paralle to the Z direction.

FIG. 5E shows a variant of a cross-sectional view of FIG. 5A. As shown in FIG. 5E, a cross section of the first dielectric block 1020a, which is taken along a plane perpendicular to the Z direction, is in a shape of a sector having a central angle of about 90° and a central point located on a Z-direction edge of the dielectric body.

FIG. 5F shows a variant of the quarter-type resonant unit of FIG. 4. In the resonant unit of FIG. 5F, an intersection line of the planes where the first lateral end face 1020a-s1 and the second lateral end face 1020a-s2 of the first dielectric block are located is close to with the Z-direction edge of the dielectric body. The first lateral end face 1020a-s1 and the second lateral end face 1020a-s2 each serve as a bottom of a notch 1020n formed in a corresponding surface of the dielectric body 1020 where the Z-direction edge 1020e is located. It is possible that only one of the first lateral end face and the second lateral end face is set further back than the respective surface of the dielectric body. Optionally or additionally, a recess 1020r may be formed in the first lateral end face 1020a-s1 and/or the second lateral end face 1020a-s2, as shown in FIG. 5G. The recess may be used for housing a connector therein. Alternatively, the recess may be used for adjusting frequency by removing part of the metalized area of the recess. The notch or the recess may have their inner surfaces metalized or non-metalized in areas selected according to practical needs.

### Third Embodiment of Resonant Unit

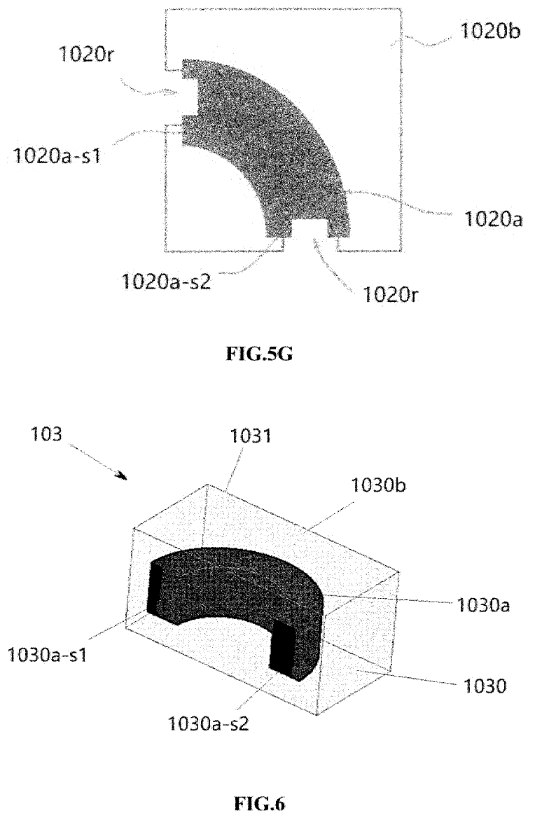

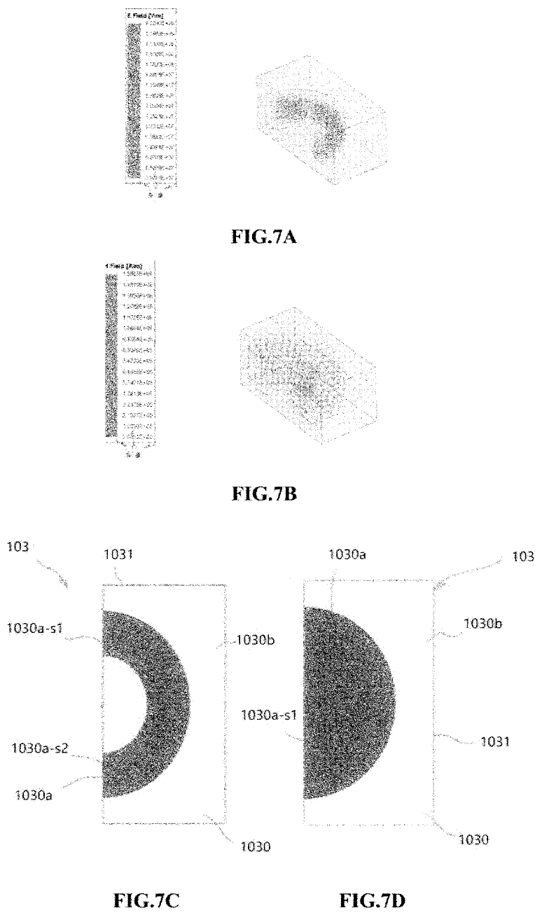

FIG. 6 shows a perspective view of a resonant unit according to a third embodiment of the present disclosure. Similar to the resonant unit of the second embodiment, the resonant unit of the third embodiment comprises a one-piece dielectric body 1030 composed of a first dielectric block 1030a and a second dielectric block 1030b and a conductive layer 1031 covering the dielectric body.
FIGS. 7C and 7D show cross sectional views of the resonant unit 103 according to a third embodiment of the present disclosure, which are taken along a plane perpendicular to the Z direction.

In the resonant unit of the third embodiment, a cross section of the first dielectric block 1030a, which is taken along a plane perpendicular to the Z direction, is in a shape of a semi-circle or a semi-ring having a center located on a surface of the dielectric body 1030 extending parallel to the Z direction. In case of a semi-ring shaped cross-section of the first dielectric block as shown in FIG. 7C, the first dielectric block 1030a has lateral end faces 1030a-s1, 1030a-s2 exposed without being covered by the second dielectric material but metalized in conductivity connection with the conductive layer 1031. In case of a semi-circle shaped cross-section of the first dielectric block as shown in FIG. 7D, the first dielectric block 1030a has a lateral end face 1030a-s1 exposed without being covered by the second dielectric material but metalized in conductivity connection with the conductive layer 1031.

In another word, the resonant unit 103 according to the third embodiment may be like a resonant unit obtained by cutting a resonant unit of the first embodiment into halves, taking one half and having the newly generated section (including newly generated sections 1030a-s1, 1030a-s2 of the first dielectric block 1030a) metalized. So, taken in this sense, the resonant unit 103 according to the third embodiment, which may function as a basic resonant unit, can be referred to as a “half-type resonant unit” hereinbelow.

FIGS. 7A and 7B show the E-field and H-field created in the half-type resonant unit 103. From FIG. 7A and FIG. 7B it can be seen that the half-type resonant unit is not only made smaller, but also able to create an energy field in a desired manner.

Although it is shown in FIGS. 7C and 7D that the first dielectric block 1030a has a semi-circle or semi-ring shaped cross section when viewed along the Z direction, it can be understood that other cross-sectional shapes than the semi-circle or semi-ring shape are also possible as long as an appropriate energy field can be created by the first dielectric block 1030a in the resonance cavity defined by the conductive layer 1031 covering the dielectric body.

For resonant units of all the above embodiments, both the first and second dielectric materials are selected from ceramic materials. Thereby it is possible that the dielectric body is easily made integral by having both the first dielectric block and the second dielectric block come into being during a single sintering process, or by bonding together the first dielectric block and the second dielectric block that are formed separately by sintering.

Although it is described that the one-piece dielectric body 1010, 1020, 1030 of the resonant unit 101, 102, 103 comprises only the first and second dielectric materials, it can be understood that the resonant unit of the present disclosure may comprise more than two kinds of dielectric materials. For example, the second dielectric block in the resonant unit of the present disclosure may be configured to have a double walled structure comprising walls made of two different dielectric materials with a lower dielectric constant than that of the first dielectric material for the first dielectric block.

The conductive layer may be a silver layer. It can be formed by plating on ceramic materials.

### Application of Resonant Unit

### A First Example

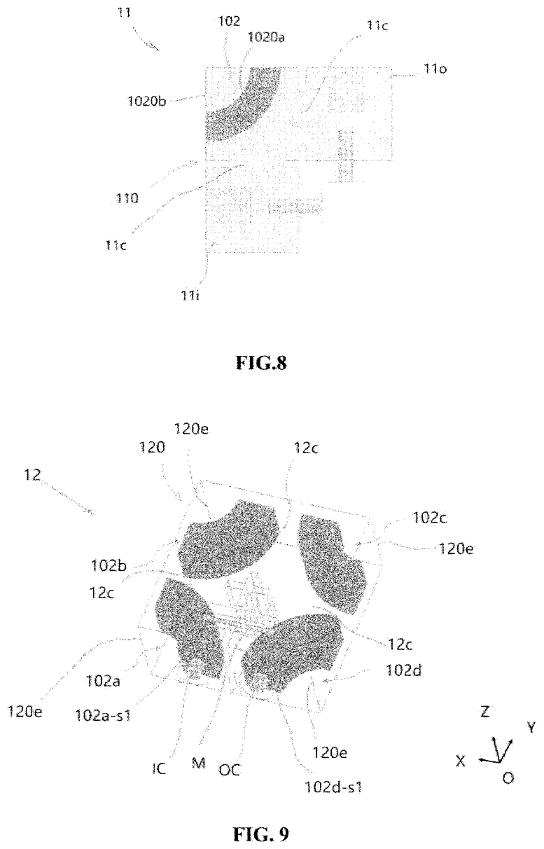

FIG. 8 shows an example of how to make use of the resonant unit according to the second embodiment of the present disclosure. Specifically, FIG. 8 shows a filter 11 according to a first embodiment of the present disclosure, comprising one “quarter-type” resonant unit 102, a signal input resonator 11i connected with a signal input port (unshown) and coupled with the “quarter-type” resonant unit 102 by a coupling window 11c therebetween, and a signal output resonator 110 coupled with the “quarter-type” resonant unit 102 by a coupling window 11c therebetween and connected with a signal output port (unshown). The signal input resonator 11i and the signal output resonator 110 are dielectric resonators having dielectric blocks made of a dielectric material identical to the second dielectric material of the resonant unit.

In a preferable embodiment, the signal input resonator and the signal output resonator are ceramic waveguide resonators, and the second dielectric material of the quarter-type resonant unit 102 is identical to the ceramic material for signal input resonator and the signal output resonator, but a different ceramic material, which has a higher dielectric constant than the second dielectric material, is chosen for the first dielectric block 1020a. In this case, the whole mainbody 110 of the filter 11 can be made into one piece by having the first dielectric block and the second dielectric block sintered together. And dielectric coupling windows 11c between the signal input resonator/the signal output resonator and the quarter-type resonant unit can be disposed directly during the sintering process.

The position or orientation of the first dielectric block 1020a in FIG. 8 is just shown as one illustrative example, and other configuration or orientation of the first dielectric block 1020a in the resonant unit or other location of the signal input resonator/the signal output resonator with respect to the resonant unit is also possible, as long as a desired transmission path is formed in the filter.

### A Second Example

FIG. 9 shows a filter 12 according to a second embodiment of the present disclosure comprising four quarter-type resonant units, i.e. a first resonant unit 102a, a second resonant unit 102b, a third resonant unit 102c and a fourth resonant unit 102d. The four resonant units are connected integrally in a 2×2 array as a one-piece main body 120 and coupled by dielectric coupling windows 12c disposed therebetween so that a transmission path capable of transmitting a signal along the first resonant unit 102a, the second resonant unit 102b, the third resonant unit 102c and the fourth resonant unit 102d is formed in the filter.

As shown in FIGS. 9-11, all the first dielectric blocks of the first resonant unit 102a, the second resonant unit 102b, the third resonant unit 102c and the fourth resonant unit 102d extend longitudinally in the Z direction. And cross sections of the first dielectric blocks, taken along a plane perpendicular to the Z direction, each are in a shape of an annular sector and have a central point located on one of Z-direction edges 120-e of the one-piece main body 120. The signal input port in the form of an input connector IC is inserted into a recess or a blind hole formed in a lateral end surface 102a-s1 of the first dielectric block of the first resonant unit 102a. And the signal output port in the form of an output connector OC is inserted into a recess or a blind hole formed in a lateral end surface 102d-s1 of the first dielectric block of the fourth resonant unit 102d.

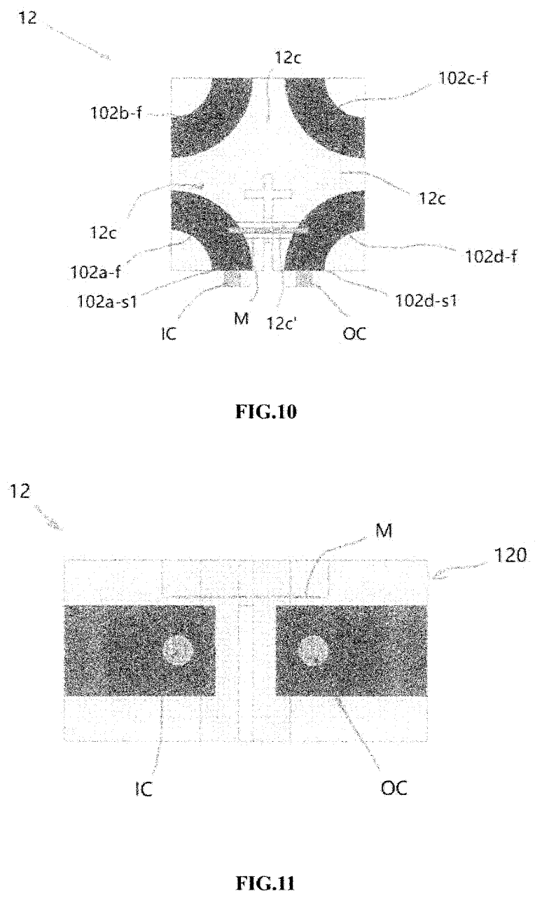

A metal strip M extends through a dielectric coupling window 12c′ between the first resonant unit 102a and the fourth resonant unit 102d, with each end thereof extending into one of the second dielectric blocks of the first and fourth resonant units respectively but being spaced from the first dielectric blocks of the first and fourth resonant units, as can be seen from FIG. 10 and FIG. 11.

The coupling windows 12c between the first and second resonant units, between the second and third resonant units, and between the third and fourth resonant units can be formed by removing the conductive film in areas of their opposing surfaces, for example, by laser etching, so that in the area of the coupling windows the second dielectric material is continuous for signal transmission. Alternatively, they can be formed directly during the sintering process. As for the coupling window 12c′ between the first and fourth resonant units, an elongate bar of the second dielectric material is made with a metal strip disposed therein, and then the bar with the metal strip is put into aligned grooves in the first and fourth resonant units so that the bar may function as a dielectric coupling window coupling the first resonant unit 102a and fourth resonant unit 102d.

The filter 12 as shown in FIG. 9 can be made integrally, for example, by sintering, or can be assembled into one piece, as shown in FIG. 12. As can be seen from FIG. 12, the filter 12 has a main body 120 made of the second electric material. In the main body 120, channels 102-c are provided for housing the first dielectric blocks 102a-f, 102b-f, 102c-f, 102d-f therein. The first dielectric blocks, which are made separately, may be assembled into the channels 102-c, for example, by bonding. Then the mainbody assembled with the first dielectric blocks may have all their exposed surfaces metalized as a whole.

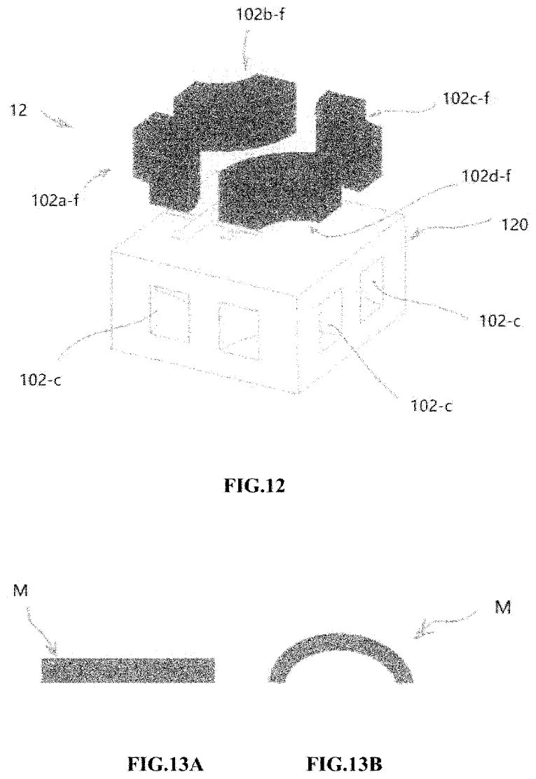

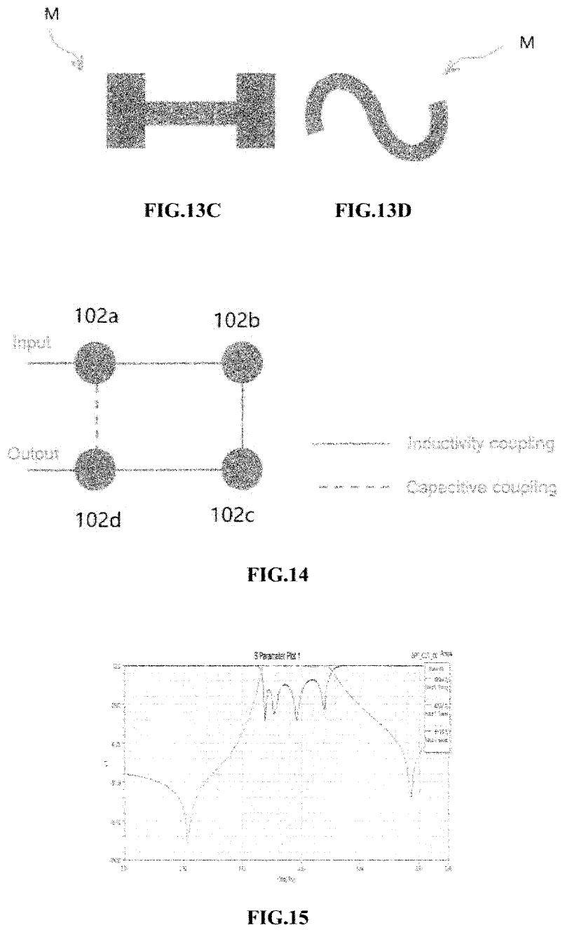

According to the specific requirement on cross-coupling between the first and fourth resonant units, the metal strip may be configured differently. For example, the metal strip M may be designed to have a bar-shaped (see FIG. 13A), arc-shaped(see FIG. 13B), I-shaped, H-shaped (see FIG. 13C) or S-shaped (see FIG. 13D) outline. The metal strip can be designed in the form of a metalized pattern extending through the dielectric coupling window of the second dielectric material.

FIG. 14 shows a topology of the filter as shown in FIG. 9. The inductivity coupling between the first and second resonant units, between the second and third resonant units and between the third and fourth resonant units is realized by means of coupling windows disposed therebetween, and the capacitive coupling or cross-coupling between the first and fourth resonant units is achieved by the metal strip.

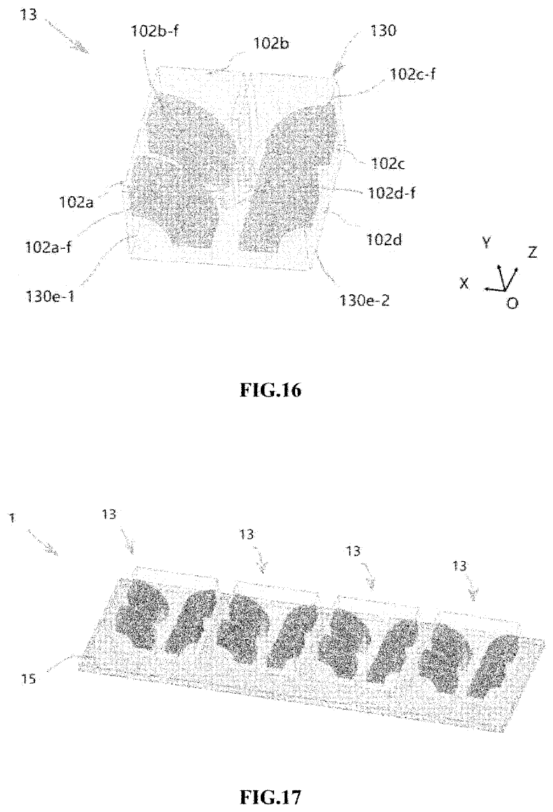

FIG. 15 shows the S parameter curve of the filter as shown in FIG. 9. From the S parameter curve shown, it can be seen that the filter according to the present disclosure exhibits a good RF performance with low loss.

### A Third Example

FIG. 16 shows a perspective view of a filter 13 according to a third embodiment of the present disclosure. Different from the filter 12 of the second embodiment, the filter 13 of the third embodiment has the first dielectric blocks 102a-f, 102b-f, 102c-f, 102d-f of the quarter-type resonant units 102a, 102b, 102c, 102d oriented differently.

Specifically, as shown in FIG. 16, all the first dielectric blocks of the first resonant unit 102a, the second resonant unit 102b, the third resonant unit 102c and the fourth resonant unit 102d extend longitudinally in the Z direction, and cross sections of the first dielectric blocks, taken along a plane perpendicular to the Z direction, each are in a shape of an annular sector, wherein the annular-sector-shaped cross sections of the first dielectric blocks 102a-f, 102b-f of the first resonant unit 102a and the second resonant unit 102b have central points located on a first Z-direction edge 130e-1 of the one-piece main body 130, and the annular-sector-shaped cross sections of the first dielectric blocks 102c-f, 102d-f of the third resonant unit 102c and the fourth resonant unit 102d have central points located on a second Z-direction edge 130e-2 of the one-piece main body 130. The first Z-direction edge 130e-1 is adjacent to the second Z-direction edge 130e-2 and coplanar with the bottom surface of the one-piece main body 130 extending parallel to the Z direction.

For the filter 13 of the third embodiment of the present application, the input or output connectors may be assembled in flexible and easy manner to the lateral end surfaces of the first dielectric blocks according to actual space requirements.

For achieving different couplings and tuning solutions, the orientations of the resonant units 102a, 102b, 102c, 102d can be configured differently.

Although it is shown in FIGS. 9 and 16 that all the resonant units applied in one filter are quarter type resonant unit, it can be understood that different types of resonant units of the present disclosure can be used in one filter. In an embodiment, the filter may further comprises at least one resonator provided in connection with the at least one resonant unit of the present disclosure, the at least one resonantor being same or different to the at least one resonant unit of the present disclosure.

As shown in FIG. 17, four filters 13 of the third embodiment are mounted onto a PCB board 15, for example, by surface mounting technology (for example, soldering through metalized surface or metalized signal pad or signal pin), so that a filter assembly 1 can be easily made as compact as possible according to practical needs. Thus, the production efficiency can be greatly improved.

Also, although it is shown in FIG. 17 that all the filters mounted onto the PCB board are filters of the third embodiment, it can be understood that, filters in different configurations can be integrated on a single PCB board in a desired manner as well.

According the present disclosure, an antenna filter unit or a radio can be made with at least one filter or at least one filter assembly as said in the above.

According to the present disclosure, the resonant unit makes it possible to obtain a small sized resonator, a duplexer, a filter, a radio or an antenna filter unit, with low loss and improved Q value. Also, it is easy to be integrated with other functional elements, and easy to produce with high production efficiency.

### In the Description of the Present Disclosure, it Should Be Understood That the

orientation or position relationship indicated by the terms “up/upper”, “down/downwards”, “top”, “bottom”, “inward”, “outward”, “horizontal”, “vertical” and so on is based on the orientation or position relationship when the filter is placed in a position as shown, only for the convenience of describing the invention and simplifying the description, rather than indicating or implying that the filter or element must have a specific orientation, or must be constructed and operated in a specific orientation. They should not be interpreted as limitative for the inventions revealed in the present disclosure.

References in the present disclosure to “an embodiment”, “another embodiment” and so on, indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether or not explicitly described.

It should be understood that, the term “and/or” includes any and all combinations of one or more of the associated listed terms.

The terminology used herein is for the purpose of describing particular embodiments only and is not intended to limit the present disclosure. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components, but do not preclude the presence or addition of one or more other features, elements, components and/or combinations thereof. The terms “connect”, “connects”, “connecting” and/or “connected” used herein cover the direct and/or indirect connection between two elements.

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-Limiting and exemplary embodiments of this disclosure.

1. A resonant unit for a filter, comprising a one-piece dielectric body having surfaces extending in planes defined by any two of three directions X, Y, Z which are perpendicular to each other and a conductive layer covering the surfaces of the dielectric body, characterized in that, the dielectic body comprises a first dielectric block made of a first dielectric material and extending longitudinally along the Z direction and a second dielectric block made of a second dielectric material, wherein the first dielectric block is embedded in the second dielectric material with both longitudinal ends of the first dielectric block being covered by the second dielectric material, and the first dielectric material has a dielectric constant greater than that of the second dielectric material.

2-3. (canceled)

4. The resonant unit according to claim 1, characterized in that the first dielectric block is in the form of a plate extending longitudinally along the Z direction and having a first lateral end face extending in a X-Z plane, a second lateral end face extending in a Y-Z plane, and side faces extending between the first and second lateral end faces around a Z-direction edge of the dielectric body, wherein the first lateral end face and the second lateral end face are not covered by the second dielectric material but fully or partially metalized in grounded connection with the conductive layer, and an intersection line of the planes where the first lateral end face and the second lateral end face are located is close to or coincident with the Z-direction edge.

5. The resonant unit according to claim 4, characterized in that, the side faces of the first dielectric block when viewed along the Z direction, are flat, curved or angled.

6. The resonant unit according to claim 5, characterized in that, a cross section of the first dielectric block, which is taken along a plane perpendicular to the Z direction, is in a shape of an annular sector.

7. The resonant unit according to claim 4, characterized in that, at least one of the first lateral end face and the second lateral end face serves as a bottom of a notch formed in a corresponding surface of the dielectric body where the Z-direction edge is located.

8. The resonant unit according to claim 4, characterized in that, a recess is formed in the first lateral end face or the second lateral end face.

9. The resonant unit according to claim 1, characterized in that a cross section of the first dielectric block, which is taken along a plane perpendicular to the Z direction, is in a shape of a sector having a central angle of about 90° and a central point located on a Z-direction edge of the dielectric body.

10. The resonant unit according to claim 1, characterized in that, a cross section of the first dielectric block, which is taken along a plane perpendicular to the Z direction, is in a shape of a semi-circle or a semi-ring having a center located on a surface of the dielectric body extending parallel to the Z direction.

11. The resonant unit according to claim 1, characterized in that, both the first and second dielectric materials are selected from ceramic materials.

12. The resonant unit according to claim 11, characterized in that, the dielectric body is made integral by having both the first dielectric block and the second dielectric block come into being during a single sintering process, or by bonding together the first dielectric block and the second dielectric block that are formed separately by sintering.

13. A filter comprising at least one resonant unit according to claim 1, a signal input port connected with the least one resonant unit for inputting a signal into the at least one resonant unit, and a signal output port connected with the at least one resonant unit for obtaining an output signal.

14. The filter according to claim 13, wherein the filter further comprises at least one resonator provided in connection with the at least one resonant unit, the at least one resonator being same or different to the at least one resonant unit.

15. The filter according to claim 13, wherein the filter comprises one resonant unit, a signal input resonator connected with the signal input port and coupled with the resonant unit by a coupling window therebetween, and a signal output resonator coupled with the resonant unit by a coupling window therebetween and connected with the signal output port, the signal input resonator and the signal output resonator being dielectric resonators having dielectric blocks made of a dielectric material identical to the second dielectric material of the resonant unit.

16. The filter according to claim 13, wherein the at least one resonant unit comprises a first resonant unit, a second resonant unit, a third resonant unit and a fourth resonant unit which are connected integrally in a 2×2 array as a one-piece main body and coupled by coupling windows therebetween so that a transmission path capable of transmitting a signal along the first resonant unit, the second resonant unit, the third resonant unit and the fourth resonant unit is formed in the filter.

17. The filter according to claim 16, wherein all the first dielectric blocks of the first resonant unit the second resonant unit, the third resonant unit and the fourth resonant unit extend longitudinally in the Z direction, and cross sections of the first dielectric blocks, taken along a plane perpendicular to the Z direction, each are in a shape of an annular sector and have a central point located on one of Z-direction edges of the one-piece main body.

18. The filter according to claim 17, wherein, the signal input port in the form of an input connector (IC) is inserted into a recess formed in a lateral end surface of the first dielectric block of the first resonant unit and/or, the signal output port in the form of an output connector (OC) is inserted into a recess formed in a lateral end surface of the first dielectric block of the fourth resonant unit.

19. The filter according to claim 18, wherein, a metal strip (M) extends through a coupling window between the first resonant unit and the fourth resonant unit, with each end thereof extending into one of the second dielectric blocks of the first and fourth resonant units respectively but being spaced from the first dielectric blocks of the first and fourth resonant units.

20. The filter according to claim 19, wherein, the metal strip is in the form of a sheet having an arc-shaped, I-shaped, H-shaped or S-shaped outline.

21. The filter according to claim 16, wherein all the first dielectric blocks of the first resonant unit, the second resonant unit, the third resonant unit and the fourth resonant unit extend longitudinally in the Z direction, and cross sections of the first dielectric blocks, taken along a plane perpendicular to the Z direction, each are in a shape of an annular sector, wherein the annular-sector-shaped cross sections of the first dielectric blocks of the first and second resonant units have central points located on a first Z-direction edge of the one-piece main body, and the annular-sector-shaped cross sections of the first dielectric blocks of the third and fourth resonant units have central points located on a second Z-direction edge of the one-piece main body, the first Z-direction edge being adjacent to the second Z-direction edge

22. A filter assembly, comprising at least one filter according to claim 13, and a PCB board on which the at least one filter is mounted.

23-24. (canceled)
